(19) United States
(12) Patent Application Publication
(10) Pub. No.: US 2021/0200917 A1
(43) Pub. Date: Jul. 1, 2021

(54) BASIC FLOW-FIELD OF DOUBLE STRAIGHT CONICAL SHOCK WAVES WITH CONTROLLABLE DOWNSTREAM FLOW-FIELD PARAMETERS AND DESIGN METHOD THEREOF

(71) Applicants: Southwest University of Science and Technology, Mianyang (CN); China Aerodynamics Research and Development Center, Mianyang City (CN)

(72) Inventors: Wenyou QIAO, Mianyang (CN); Yunan JIN, Mianyang (CN); Anyuan YU, Mianyang (CN); Dong LIU, Mianyang (CN); Dawei YANG, Mianyang (CN); Lipeng QU, Mianyang (CN)

(21) Appl. No.: 17/138,174

(22) Filed: Dec. 30, 2020

(30) Foreign Application Priority Data
Dec. 31, 2019 (CN) 201911402015.X

(51) Int. Cl. G06F 30/20

(52) U.S. Cl. CPC G06F 30/20; G06F 2111/10

(57) ABSTRACT

Provided are a basic flow-field of double straight conical shock waves with controllable downstream flow-field parameters, and a design method thereof, including the steps of: 1) designing an incident straight shock wave and a dependent-domain flow-field downstream thereof; 2) designing an isentropic compression-domain flow-field and a reflected straight shock wave; 3) designing a dependent-domain flow-field downstream of the reflected straight shock wave; 4) designing a rectified domain flow-field; and 5) spatially combining the dependent-domain flow-field downstream of the incident straight shock wave, the isentropic compression-domain flow-field, the dependent-domain flow-field downstream of the reflected straight shock wave and the rectified domain flow-field obtained in step 1) to step 4) in sequence into the entire basic flow-field for an inward turning inlet.

### TECHNICAL FIELD

The present disclosure relates to the field of basic flow-field design for hypersonic inward turning inlets and is applicable to the design of inward turning inlets at Mach numbers above 3.

### BACKGROUND

Under a hypersonic condition, an inward turning inlet may have higher compression efficiency and smaller size and external drag than those of the traditional two-dimensional, axisymmetric and sidewall compression inlets. Inward turning inlets have increasingly extensive applications in the design of modern air-breathing hypersonic vehicles. At present, most of inward turning inlets are designed based on an osculating flow method by the steps of: first designing an inviscid axisymmetric basic flow-field according to vehicle design points; then, with given capture section shape of the inward turning inlet, determining the initial contour of the inward turning inlet in the basic flow-field by streamline tracing; and finally determining the final inlet configuration using viscosity correction and cross-section transition techniques. Here, the basic flow-field plays a decisive role in aerodynamic performance of the inward turning inlet.

Currently, the basic flow-field of an inward turning inlet mainly comes in following types: Busemann flow-field, truncated Busemann flow-field, combined Internal Conical Flow “C” (ICFC) flow-field, basic flow-field with controllable section compression rules, and basic flow-field with controllable flow-field parameters at the exit section. The Busemann flow-field was extensively used at the early development stage of inward turning inlets, but had larger isentropic compression ratio, leading to poor aerodynamic performance of inlets. A truncated Busemann flow-field can effectively avoid the problem of the Busemann flow-field, but may still affect the aerodynamic performance of the inlet because of continuous reflection of the reflected shock wave in the isolator due to the flow-field structure deviating from the original characteristic of the Busemann flow-field. To realize a basic flow-field with uniform structures of incident and reflected straight shock waves, Guo Junliang constructed ICFC shock wave flow-field by joining the Internal Conical Flow “A” (ICFA) flow-field with the truncated Busemann flow-field, but numerical simulation results indicated that such a flow-field did not achieve the expected design goal. Zhang Kunyuan's team proposed a basic flow-field with controllable section compression rules, in which internal and external compression ratios of the inlet can be effectively controlled, so that the aerodynamic performance of the inward turning inlet can be effectively improved. This basic flow-field design method, however, did not consider the uniformity of flow-field parameters at the throat section, leaving limited room for improvement on the aerodynamic performance of the inlet. To improve the design efficiency of an inward turning inlet, Fang Xingjun and Liu Yi in Zhang Kunyuan's team proposed a two-dimensional flow-field design method based on exit flow-field parameters, and Han Weiqiang further proposed a basic flow-field design method for designing an axisymmetric basic flow-field based on a reflected shock wave and flow-field parameters downstream thereof. Nonetheless, these methods fail to effectively solve the problem of matching between flow-field parameters upstream of the reflected shock wave and dependent-domain flow-field parameters downstream of the incident shock wave in principle. At present, such methods can only reproduce the flow-fields based on existing basic flow-field parameters and cannot be practicably used in the design of basic flow-fields.

Currently, it is an important direction to design a basic flow-field with incident and reflected shock waves in identical straight cone shape and ensure the distribution of flow-field parameters downstream of the reflected shock wave meet the design requirements, so as to solve the difficulties of traditional basic flow-field design methods in improving the uniformity of throat flow-field parameters and eliminating shock wave reflection in the isolatorflow-field. Therefore, it is necessary to develop a corresponding basic flow-field design method to improve the flexibility of the basic flow-field design for inward turning inlets.

### SUMMARY

An objective of the present disclosure is to provide a design method of basic flow-field with the straight conical incident and reflected shock waves based on the distribution of flow-field parameters downstream of an incident shock wave and flow-field parameters downstream of a reflected shock wave, so that the distribution of flow-field parameters downstream of the reflected shock wave in the basic flow-field can be flexibly controlled, allowing for improvements on the flexibility of the basic flow-field design method and the design efficiency of an inward turning inlet.

The technical solution of the present disclosure is specifically explained below.

A design method for a basic flow-field of double straight conical shock waves with controllable downstream flow-field parameters comprises the following steps:

step 1, designing an incident straight shock wave 2 and a dependent-domain flow-field downstream thereof;

step 2, designing an isentropic compression-domain flow-field and a reflected straight shock wave 7;

step 3, designing a dependent-domain flow-field downstream of the reflected straight shock wave 7;

step 4, designing a rectified domain flow-field; and

step 5, spatially combining the dependent-domain flow-field downstream of the incident straight shock wave, the isentropic compression-domain flow-field, the dependent-domain flow-field downstream of the reflected straight shock wave and the rectified domain flow-field obtained in step 1 to step 4 in sequence into the entire basic flow-field for an inward turning inlet.

Preferably, step 1 specifically includes the following steps:

step 1.1, designing Internal Conical Flow “A” (ICFA) having the same angle with the incident straight shock wave 2, determining a shock wave angle β₁ of the incident straight shock wave 2 and other flow-field parameters downstream of the shock wave according to shock wave relations based on given incoming flow conditions and one flow-field parameter downstream of the incident straight shock wave 2, and solving Taylor-Maccoll equations with the flow-field parameters downstream of the incident straight shock wave 2 as initial conditions to obtain the ICFA O₀OAA₁A₂A₃ . . . Aₙ₋₁AₙO₀, where the one flow-field parameter may be any one of pressure, Mach number, density, velocity, velocity direction and temperature; and

step 1.2, with given entry radius Rᵢ of the basic flow-field and radius Ro of a center body 1, determining the positions of a starting point 3 and a lip 6 of the incident straight shock wave, emanating a streamline from the starting point 3 of the incident straight shock wave to intersect a ray O₀A₁ which emanates from the vertex 15 of the ICFA at a point A₁, emanating a streamline from the point A to intersect a ray O₀A₂ at a point A₂, and repeating as such until a streamline intersects an ICFA exit boundary 14 at a point Aₙ, where a straight shock wave O₀A can be generated by the boundary AA₁A₂A₃ Aₙ₋₁Aₙ; emanating a left-running characteristic line from the lip 6 to intersect the ray O₀A₁ at a point O₁, followed by emanating a left-running characteristic line from the point O₁ to intersect the ray O₀A₂ at a point O₂, and repeating this process until a left-running characteristic line intersects a ray O₀Aₙ₋₁ at a point Oₙ₋₁; and finally, emanating a left-running characteristic line from the point Oₙ₋₁ to intersect the boundary AA₁A₂A₃ . . . Aₙ₋₁Aₙ at a point B, where the boundary AA₁A₂A₃ . . . Aₙ₋₁B is a boundary 4 capable of generating the incident straight shock wave 2, while a boundary OO₁O₂O₃ . . . Oₙ₋₁B is an exit boundary of the dependent-domain downstream of the incident straight shock wave, and a region defined by the incident straight shock wave 2, the boundary 4 capable of generating the incident straight shock wave and the exit boundary 5 of dependent-domain downstream of the incident straight shock wave is the dependent-domain flow-field downstream of the incident straight shock wave.

Preferably, step 2 specifically includes the following steps:

step 2.1, with one given flow-field parameter downstream of the reflected shock wave at the lip, determining a shock wave angle β₂ (i.e., a sharp angle between the reflected shock wave and a velocity direction 16 downstream of incident straight shock wave at the lip 6) of the reflected straight shock wave 7 according to the shock wave relations;

step 2.2 emanating a streamline from the point O₁ to intersect the reflected straight shock wave 7 at a point C₁, determining all the flow-field parameters upstream of the reflected straight shock wave 7 at the point C₁ based on the position of the point C₁, the distribution of the selected one flow-field parameter downstream of the reflected shock wave, the shock wave relations and an isentropic relation on the streamline O₁C₁, and then adjusting the position of the point C by a correction step until the flow-field parameters upstream and downstream of the reflected straight shock wave 7 at the point C₁ satisfy a corrected streamline equation and the shock wave relations;

step 2.3, calculating the slope of a right-running characteristic line based on the flow-field parameters upstream of the reflected straight shock wave 7 at the point C₁, reversely emanating a right-running characteristic line from the point C₁ to intersect a streamline emanating from a point O₂ at a point C₁₂, determining a point P₁ in O₂-C₁ connecting line by interpolation such that a left-running characteristic line emanates from the point P₁ just passes through the point C₁₂, and solving compatibility equations of the streamline and the two characteristic lines passing through the point C₁₂ by the method of characteristics to determine the flow-field parameters of the point C₁₂; then, with the point C₁₂ and a point Oₙ₋₁ as starting points, repeating calculations to obtain the position and flow-field parameters of a point C₁ₙ₋₂; and continuously carrying out iterative calculations until a boundary C₁C₁₂ . . . C₁ₙ₋₂B₁ and the distribution of flow-field parameters thereof are obtained, hence determining the position and flow-field parameters of a point B₁ in an upper isentropic compression boundary 8; and

step 2.4, repeating step 2.2 and step 2.3 to obtain the upper isentropic compression boundary 8 BB₁B₂ . . . Bₙ₋₁C, the reflected straight shock wave 7 OC₁C₂ . . . Cₙ₋₁C and the isentropic compression domain flow-field defined by the exit boundary 5 of the dependent-domain downstream of the incident straight shock wave, the upper isentropic compression boundary 8 and the reflected straight shock wave 7.

Preferably, in step 3, parameters of the dependent-domain flow-field downstream of the reflected straight shock wave are solved; firstly, the distribution of other flow-field parameters is obtained according to the shock wave relations based on the flow-field parameters upstream of the reflected straight shock wave 7; then a boundary 13 capable of generating the reflected straight shock wave and an exit boundary 12 of the dependent-domain flow-field downstream of the reflected straight shock wave are determined using the method of inverse characteristics; and a region defined by the reflected straight shock wave 7, the boundary 13 capable of generating the reflected straight shock wave and the exit boundary 12 of the dependent-domain flow-field downstream of the reflected straight shock wave is the dependent-domain flow-field downstream of the reflected straight shock wave.

Preferably, the solving of parameters of the rectified-domain flow-field in step 4 may specifically include the following steps:

step 4.1, defining a basic flow-field exit boundary at the position of the vertex of the reflected straight shock wave that also serves as the vertex of the basic flow-field exit boundary, determining the position and flow-field parameters of a point Dₙ₋₁ to be solved, adjacent to the vertex of the reflected straight shock wave, on the basic flow-field exit boundary using the method of characteristics, emanating a streamline from a point Eₙ₋₁ on the exit boundary 12 of the dependent-domain flow-field downstream of the reflected straight shock wave to intersect the basic flow-field exit boundary 10 at a point Dₙ₋₁, and determining a point Dₙ₋₁′ on a boundary CEₙ₋₁ such that a right-running characteristic line emanating from the point Dₙ₋₁′ passes through the point Dₙ₋₁; obtaining other flow-field parameters at the point Dₙ₋₁ by simultaneous solving according to the compatibility equations of the streamline and the right-running characteristic line passing through the point Dₙ₋₁ and a distribution rule of one flow-field parameter on the basic flow-field exit boundary 10, where the one flow-field parameter may be any one of pressure, Mach number, density, velocity, velocity direction and temperature;

step 4.2, connecting a point Eₙ₋₂ and the point Dₙ₋₁, emanating a streamline from the point Eₙ₋₂ to intersect a left-running characteristic line which reversely emanates from the point Dₙ₋₁ at a point E₂ₙ₋₂, and determining a point Q on a boundary Eₙ₋₂Dₙ₋₁ such that a right-running characteristic line emanating from the point Q just passes through the point E₂ₙ₋₂; determining the flow-field parameters at the point E₂ₙ₋₂ by simultaneously solving the compatibility equations of the streamline and the two characteristic lines passing through the point E₂ₙ₋₂, and repeating this process until a streamline EE₂₁ emanating from point E is determined; and

step 4.3, repeating step 4.1 and step 4.2 to obtain a boundary EE₂₁E₃₁ . . . D that allows one flow-field parameter on the basic flow-field exit boundary 10 to accord with a given distribution rule, where the boundary EE₂₁E₃₁ . . . D serves as a lower rectified-region boundary 11.

To achieve the above objective, the present disclosure further provides a basic flow-field of double straight conical shock waves with controllable downstream flow-field parameters obtained by the design method as described above.

The present disclosure has the following advantages: using the basic flow-field obtained in the present disclosure, incident and reflected shock waves in identical straight cone shape can be obtained, and the flow-field parameters downstream of the reflected straight shock wave can be controlled. The problem of failing to design a basic flow-field with double straight conical shock waves and to flexibly control the flow-field parameters downstream of the reflected straight shock wave in the identical straight cone shape in the prior art can be effectively solved, and the flexibility of the basic flow-field design for an inward turning inlet can be further improved.

### BRIEF DESCRIPTION OF THE DRAWINGS

FIG. 1 is a schematic diagram of design of a double straight conical basic flow-field with controllable downstream flow-field parameters according to an embodiment of the present disclosure.

FIG. 2 is a schematic diagram of solving of a dependent-domain flow-field downstream of an incident shock wave according to an embodiment of the present disclosure.

FIG. 3 is a schematic diagram of determining of an angle of a reflected shock wave according to an embodiment of the present disclosure.

FIG. 4 shows a schematic diagram of determining flow-field parameters upstream and downstream of a shock wave in the vicinity of a lip according to an embodiment of the present disclosure.

FIG. 5 shows a mesh of characteristic lines for solving of isentropic compression domain flow-field and boundaries according to an embodiment of the present disclosure.

FIG. 6 shows a dependent-domain flow-field downstream of a reflected shock wave according to an embodiment of the present disclosure.

FIG. 7 shows a mesh of characteristic lines for points to be solved at the exit section according to an embodiment of the present disclosure.

FIG. 8 shows principles of solving a rectified domain flow-field with one controllable flow-field parameter at the exit section according to an embodiment of the present disclosure.

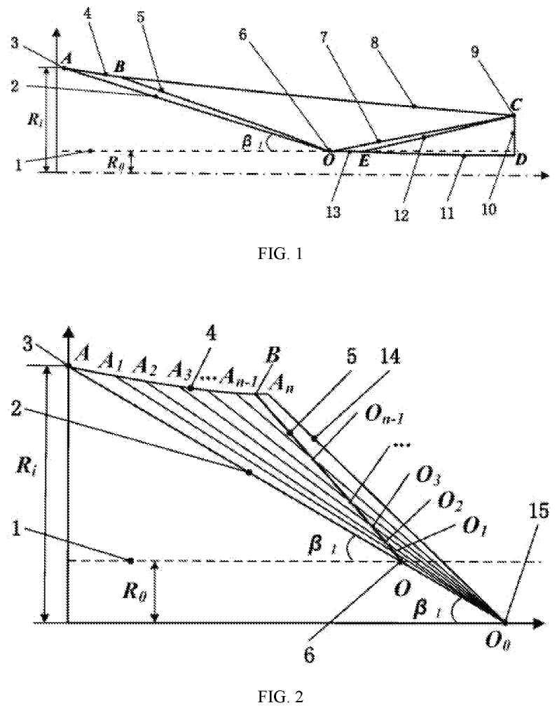

In the drawings, 1 denotes a center body, while 2 an incident straight shock wave, 3 an incident shock wave starting point, 4 a boundary capable of generating the incident shock wave, 5 a dependent-domain exit boundary downstream of the incident straight shock wave, 6 a lip, 7 a reflected straight shock wave, 8 an upper isentropic compression boundary, 9 a reflected straight shock wave vertex, 10 a basic flow-field exit boundary, 11a lower rectified domain boundary, 12 a dependent-domain exit boundary downstream of the reflected straight shock wave, 13 a boundary capable of generating the reflected straight shock wave, 14 an ICFA exit boundary, 15 an ICFA vertex, and 16 a velocity direction downstream of the incident straight shock wave at the lip.

### DETAILED DESCRIPTION OF EMBODIMENTS

Embodiments of the present disclosure will be described below with specific examples. Other advantages and effects of the present disclosure will become readily apparent to those skilled in the art from the contents disclosed by this specification. The present disclosure can also be carried out or practiced in other different embodiments. Various modifications or alterations can be made to various details in this specification based on different viewpoints and uses without departing from the spirit of the present disclosure.

### Embodiment 1

1) An incident straight shock wave 2 and an after-shock dependent-domain flow-field thereof are designed.

2) An isentropic compression-domain flow-field and a reflected straight shock wave 7 are designed.

3) A dependent-domain flow-field downstream of the reflected straight shock wave 7 is designed.

4) A rectified domain flow-field is designed.

5) The dependent-domain flow-field downstream of the incident straight shock wave, the isentropic compression-domain flow-field, the dependent-domain flow-field downstream of the reflected straight shock wave and the rectified domain flow-field obtained in step 1) to step 4) are spatially combined in sequence into the entire basic flow-field for an inward turning inlet.

### Embodiment 2

A design method for a basic flow-field of double straight conical shock waves with controllable downstream flow-field parameters includes steps as follows.

1) An incident straight shock wave 2 and a dependent-domain flow-field downstream thereof are designed. This design mainly includes the following steps: CD Design of Internal Conical Flow “A” (ICFA) having the same angle with the incident straight shock wave 2: a shock wave angle β₁ of the incident straight shock wave 2 and other flow-field parameters downstream of the shock wave are determined by shock wave relations based on given incoming flow conditions and one flow-field parameter downstream of the incident straight shock wave 2, and Taylor-Maccoll equations are solved with the flow-field parameters downstream of the incident straight shock wave 2 as initial conditions to obtain the ICFA O₀OAA₁A₂A₃ . . . Aₙ₋₁ AₙO₀ as shown in FIG. 2. The one flow-field parameter may be any one of pressure, Mach number, density, velocity, velocity direction and temperature.

\textcircled{2} With given entry radius Rᵢ of the basic flow-field and radius Ro of a center body 1, the positions of starting point 3 and lip 6 of the incident straight shock wave are determined. A streamline emanates from the starting point 3 of the incident straight shock wave and intersects ray O₀A₁ emanating from the vertex 15 of the ICFA at point A₁, and a streamline emanates from the point A₁ and intersects ray O₀A₂ at point A₂. This process is repeated until a streamline intersects ICFA exit boundary 14 at point Aₙ, where a straight shock wave O₀A can be generated by the boundary AA₁A₂A₃ . . . Aₙ₋₁Aₙ. A left-running characteristic line emanates from the lip 6 and intersects the ray O₀A₁ at point O₁, and a left-running characteristic line emanates from the point O₁ and intersects the ray O₀A₂ at point O₂. This process is repeated until a left-running characteristic line intersects ray O₀Aₙ₋₁ at point Oₙ₋₁. Finally, a left-running characteristic line emanates from the point Oₙ₋₁ and intersects the boundary AA₁A₂A₃ . . . Aₙ₋₁Aₙ at point B. The boundary AA₁A₂A₃ . . . Aₙ₋₁B is the boundary 4 capable of generating the incident straight shock wave 2, while the boundary OO₁O₂O₃ . . . Oₙ₋₁B an exit boundary 5 of the dependent-domain downstream of the incident straight shock wave, and the region defined by the incident straight shock wave 2, the boundary 4 capable of generating the incident straight shock wave and the exit boundary 5 of dependent-domain downstream of the incident straight shock wave is the dependent-domain flow-field downstream of the incident straight shock wave.

2) An isentropic compression-domain flow-field and a reflected straight shock wave 7 are designed. This design mainly includes the following steps:

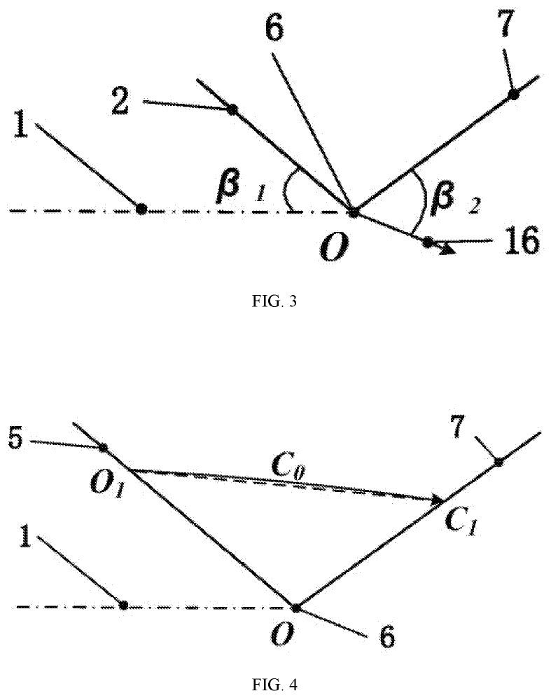

\textcircled{1} As shown in FIG. 3, with one given flow-field parameter downstream of the reflected shock wave at the lip 6, a shock wave angle β₂ (i.e., a sharp angle between the reflected shock wave and a velocity direction 16 downstream of the incident straight shock wave at the lip 6) of the reflected straight shock wave 7 is determined according to the shock wave relations.

\textcircled{2} As shown in FIG. 4, a streamline emanates from the point O₁ and intersects the reflected straight shock wave 7 at point C₁. All the flow-field parameters upstream of the reflected straight shock wave 7 at the point C₁ are determined based on the position of the point C₁, the distribution of the selected one flow-field parameter downstream of the reflected shock wave, the shock wave relations and an isentropic relation on the streamline O₁C₁, and then the position of the point C₁ is adjusted by a correction step until the flow-field parameters upstream and downstream of the reflected straight shock wave 7 at the point C₁ satisfy a corrected streamline equation and the shock wave relations.

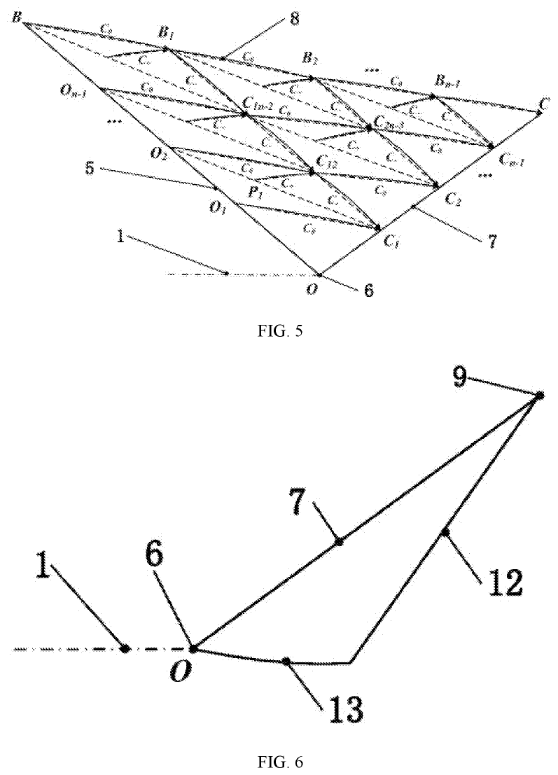

\textcircled{3} As shown in FIG. 5, the slope of a right-running characteristic line is calculated based on the flow-field parameters upstream of the reflected straight shock wave 7 at the point C₁. A right-running characteristic line reversely emanates from the point C₁ and intersects a streamline emanating from point O₂ at point C₁₂. A point P₁ is determined in O₂-C₁ connecting line by interpolation such that a left-running characteristic line emanates from the point P₁ just passes through the point C₁₂, and the compatibility equations of the streamline and the two characteristic lines passing through the point C₁₂ are solved by the method of characteristics to determine the flow-field parameters of the point C₁₂. Then, with the point C₁₂ and point Oₙ₋₁ as starting points, the calculations are repeated to obtain the position and flow-field parameters of point C₁ₙ₋₂. Iterative calculations are carried out continuously until boundary C₁C₁₂ . . . C₁ₙ₋₂B₁ and the distribution of flow-field parameters thereof are obtained, hence the position and flow-field parameters of point B₁ in the upper isentropic compression boundary 8 are determined.

\textcircled{4} Step \textcircled{2} and step \textcircled{3} are repeated to obtain the upper isentropic compression boundary 8 BB₁B₂ . . . Bₙ₋₁C, the reflected straight shock wave 7 OC₁C₂ . . . Cₙ₋₁C and the isentropic compression-domain flow-field defined by the exit boundary 5 of the dependent-domain downstream of the incident straight shock wave, the upper isentropic compression boundary 8 and the reflected straight shock wave 7.

3) A dependent-domain flow-field downstream of the reflected straight shock wave 7 is designed. The parameters of the dependent-domain flow-field downstream of the reflected straight shock wave are solved with reference to FIG. 6. Firstly, the distribution of other flow-field parameters is obtained according to the shock wave relations based on the flow-field parameters upstream of the reflected straight shock wave 7, and then a boundary 13 of the reflected straight shock wave and the exit boundary 12 of the dependent-domain flow-field downstream of the reflected straight shock wave are determined using the method of inverse characteristics. A region defined by the reflected straight shock wave 7, the boundary 13 capable of generating the reflected straight shock wave and the exit boundary 12 of the dependent-domain flow-field downstream of the reflected straight shock wave is the dependent-domain flow-field downstream of the reflected straight shock wave.

4) A rectified domain flow-field is designed.

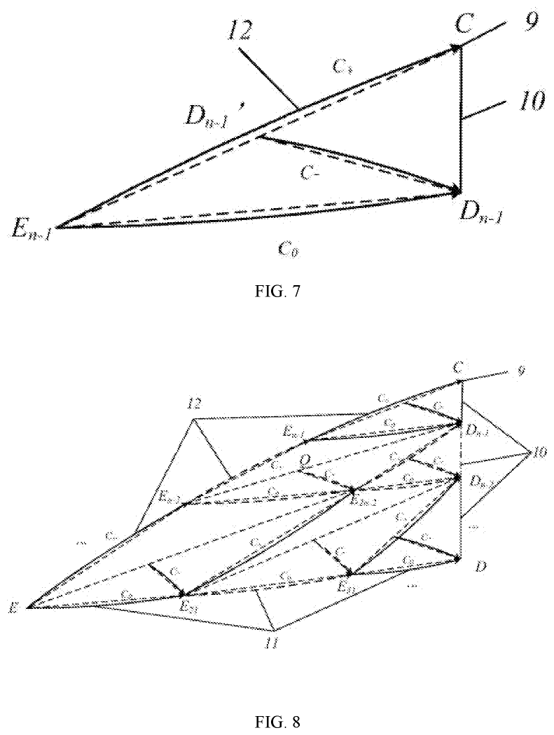

The parameters of the rectified domain flow-field are solved based on principles as shown in FIG. 7 and FIG. 8. The specific steps are as follows.

\textcircled{1} A basic flow-field exit boundary 10 is defined at the position of the vertex 9 of the reflected straight shock wave, and the vertex 9 of the reflected straight shock wave also serves as the vertex of the basic flow-field exit boundary. The position and flow-field parameters of a point to be solved, adjacent to the vertex 9 of the reflected straight shock wave, on the basic flow-field exit boundary are determined using the method of characteristics. A streamline emanates from a point Eₙ₋₁ on the exit boundary 12 of the dependent-domain flow-field downstream of the reflected straight shock wave and intersects the basic flow-field exit boundary 10 at point Dₙ₋₁, and a point Dₙ₋₁′ on boundary CEₙ₋₁ is determined such that a right-running characteristic line emanating from the point Dₙ₋₁′ passes through the point Dₙ₋₁. Other flow-field parameters at the point Dₙ₋₁ are obtained by simultaneous solving according to the compatibility equations of the streamline and the right-running characteristic line passing through the point Dₙ₋₁ and the distribution rule of one flow-field parameter on the basic flow-field exit boundary 10. The one flow-field parameter may be any one of pressure, Mach number, density, velocity, velocity direction and temperature.

\textcircled{2} Point Eₙ₋₂ and the point Dₙ₋₁ are connected. A streamline emanates from the point Eₙ₋₂ and intersects a left-running characteristic line reversely emanating from the point Dₙ₋₁ at point E₂ₙ₋₂, and a point Q on boundary Eₙ₋₂Dₙ₋₁ is determined such that a right-running characteristic line emanating from the point Q passes through the point E₂ₙ₋₂. The flow-field parameters at the point E₂ₙ₋₂ are determined by simultaneously solving the compatibility equations of the streamline and the two characteristic lines passing through the point E₂ₙ₋₂, and this process is repeated until a streamline EE₂₁ emanating from point E is determined.

\textcircled{3} Step \textcircled{1} and step \textcircled{2} are repeated to obtain boundary EE₂₁E₃₁ . . . D that allows one flow-field parameter on the basic flow-field exit boundary 10 to accord with a given distribution rule, and the boundary EE₂₁E₃₁ . . . D serves as a lower rectified domain boundary 11.

5) The dependent-domain flow-field downstream of the incident straight shock wave, the isentropic compression-domain flow-field, the dependent-domain flow-field downstream of the reflected straight shock wave and the rectified domain flow-field obtained in step 1) to step 4) are spatially combined in sequence into the entire basic flow-field for an inward turning inlet.

The foregoing embodiments are merely intended to exemplarily explain the principles and effects of the present disclosure, rather than limit the present disclosure. Any person skilled in the art can make modifications or alterations to the foregoing embodiments without departing from the spirit and scope of the present disclosure. Hence, all equivalent modifications or alterations made by those of ordinary skill in the art without departing from the spirit and technical ideas disclosed in the present disclosure shall fall within the scope defined by appended claims to the present disclosure.

What is claimed is:

1. A design method for a basic flow-field of double straight conical shock waves with controllable downstream flow-field parameters, comprising the following steps:
step 1, designing an incident straight shock wave (2) and a dependent-domain flow-field downstream thereof;
step 2, designing an isentropic compression-domain flow-field and a reflected straight shock wave (7);
step 3, designing a dependent-domain flow-field downstream of the reflected straight shock wave (7);
step 4, designing a rectified domain flow-field; and
step 5, spatially combining the dependent-domain flow-field downstream of the incident straight shock wave, the isentropic compression-domain flow-field, the dependent-domain flow-field downstream of the reflected straight shock wave and the rectified domain flow-field obtained in step 1 to step 4 in sequence into the entire basic flow-field for an inward turning inlet.

2. The design method for a basic flow-field of double straight conical shock waves with controllable downstream flow-field parameters according to claim 1, wherein
step 1 comprises:
step 1.1, designing Internal Conical Flow “A” (ICFA) having a same angle with the incident straight shock wave (2), determining a shock wave angle β₁ of the incident straight shock wave (2) and other flow-field parameters downstream of the shock wave according to shock wave relations based on given incoming flow conditions and a flow-field parameter downstream of the incident straight shock wave (2), and solving Taylor-Maccoll equations with the flow-field parameter downstream of the incident straight shock wave (2) as initial conditions to obtain the ICFA (O₀OAA₁A₂A₃ . . . Aₙ₋₁AₙO₀), wherein the flow-field parameter is any one of pressure, Mach number, density, velocity, velocity direction and temperature; and
step 1.2, with given entry radius Rᵢ of the basic flow-field and radius Ro of a center body (1), determining positions of a starting point (3) and a lip (6) of the incident straight shock wave, emanating a streamline from the starting point (3) of the incident straight shock wave to intersect a ray O₀A₁ which emanates from the vertex (15) of the ICFA at a point A₁, emanating a streamline from the point A₁ to intersect a ray O₀A₂ at a point A₂, and repeating as such until a streamline intersects an ICFA exit boundary (14) at a point Aₙ, where a boundary AA₁A₂A₃ . . . Aₙ₋₁ Aₙ is a boundary capable of generating the incident straight shock wave; emanating a left-running characteristic line from the lip (6) to intersect the ray O₀A₁ at a point O₁, followed by emanating a further left-running characteristic line from the point O₁ to intersect the ray O₀A₂ at a point O₂, and repeating this process until one of the left-running characteristic lines intersects a ray O₀Aₙ₋₁ at a point Oₙ₋₁; and emanating a still-further left-running characteristic line from the point Oₙ₋₁ to intersect the boundary AA₁A₂A₃ . . . Aₙ₋₁Aₙ at a point B, where the boundary AA₁A₂A₃ . . . Aₙ₋₁B is a boundary (4) capable of generating the incident straight shock wave (2), while a boundary OO₁O₂O₃ . . . Oₙ₋₁B is an exit boundary (5) the dependent-domain downstream of the incident straight shock wave, and a region defined by the incident straight shock wave (2), the boundary (4) capable of generating the incident straight shock wave and the exit boundary (5) of the dependent-domain downstream of the incident straight shock wave is the dependent-domain flow-field downstream of the incident straight shock wave.

3. The design method for a basic flow-field of double straight conical shock waves with controllable downstream flow-field parameters according to claim 1, wherein
step 2 comprises:
step 2.1, with one given flow-field parameter downstream of the reflected shock wave (7) at a lip (6) of the incident straight shock wave (2), determining a shock wave angle β₂ of the reflected straight shock wave (7) according to the shock wave relations, the shock wave angle β₂ being a sharp angle between the reflected shock wave and a velocity direction (16) downstream of the incident straight shock wave at the lip (6));
step 2.2, emanating a streamline from a point O₁ to intersect the reflected straight shock wave (7) at a point C₁, determining flow-field parameters upstream of the reflected straight shock wave (7) at the point C₁ based on the position of the point C₁, distribution of a selected flow-field parameter downstream of the reflected shock wave, the shock wave relations and an isentropic relation on the streamline O₁C₁, and then adjusting the position of the point C₁ by a correction step until the flow-field parameters upstream and downstream of the reflected straight shock wave (7) at the point C₁ satisfy a corrected streamline equation and the shock wave relations;
step 2.3, calculating a slope of a right-running characteristic line based on the flow-field parameters upstream of the reflected straight shock wave (7) at the point C₁, reversely emanating a right-running characteristic line from the point C₁ to intersect a streamline emanating from a point O₂ at a point C₁₂, determining a point P₁ in O₂C₁ connecting line by interpolation such that a left-running characteristic line emanates from the point P₁ just passes through the point C₁₂, and solving compatibility equations of the streamline O₁C₁, and the two characteristic lines passing through the point C₁₂ by the method of characteristics to determine the flow-field parameters of the point C₁₂; then, with the point C₁₂ and a point Oₙ₋₁ as starting points, repeating calculations to obtain the position and flow-field parameters of a point C₁ₙ₋₂; and continuously carrying out iterative calculations until a boundary C₁C₁₂ . . . C₁ₙ₋₂B₁ and the distribution of flow-field parameters thereof are obtained, hence determining a position and flow-field parameters of a point B₁ in an upper isentropic compression boundary (8); and
step 2.4, repeating step 2.2 and step 2.3 to obtain the upper isentropic compression boundary (8), the reflected straight shock wave (7) and the isentropic compression-domain flow-field defined by a dependent-domain exit boundary (5) downstream of the incident straight shock wave, the upper isentropic compression boundary (8) and the reflected straight shock wave (7).

4. The design method for a basic flow-field of double straight conical shock waves with controllable downstream flow-field parameters according to claim 1, wherein
in step 3, parameters of the dependent-domain flow-field downstream of the reflected straight shock wave are solved, including, distribution of other flow-field parameters is obtained according to the shock wave relations based on flow-field parameters upstream of the reflected straight shock wave (7); then, a boundary (13) capable of generating the reflected straight shock wave and an exit boundary (12) of the dependent-domain flow-field downstream of the reflected straight shock wave are determined using the method of inverse characteristics; and a region defined by the reflected straight shock wave (7), the boundary (13) capable of generating the reflected straight shock wave and the exit boundary (12) of the dependent-domain flow-field downstream of the reflected straight shock wave is the dependent-domain flow-field downstream of the reflected straight shock wave.

5. The design method for a basic flow-field of double straight conical shock waves with controllable downstream flow-field parameters according to claim 1, wherein
step 4 comprises solving of parameters of the rectified domain flow-field, and further comprises the following steps:
step 4.1, defining a basic flow-field exit boundary at the position of a vertex of the reflected straight shock wave that also serves as a vertex of a basic flow-field exit boundary, determining the position and flow-field parameters of a point to be solved adjacent to the vertex of the reflected straight shock wave on the basic flow-field exit boundary using the method of characteristics, emanating a streamline from a point Eₙ₋₁ on an exit boundary (12) of the dependent-domain flow-field downstream of the reflected straight shock wave to intersect the basic flow-field exit boundary (10) at a point Dₙ₋₁, and determining a point Dₙ₋₁′ on a boundary CEₙ₋₁ such that a right-running characteristic line emanating from the point Dₙ₋₁′ passes through the point Dₙ₋₁; obtaining other flow-field parameters at the point Dₙ₋₁ by simultaneous solving according to compatibility equations of the streamline and the right-running characteristic line passing through the point Dₙ₋₁ and a distribution rule of one flow-field parameter on the basic flow-field exit boundary (10), wherein the one flow-field parameter is any one of pressure, Mach number, density, velocity, velocity direction and temperature;
step 4.2 connecting a point Eₙ₋₂ and the point Dₙ₋₁, emanating a streamline from the point Eₙ₋₂ to intersect a left-running characteristic line which reversely emanates from the point Dₙ₋₁ at a point E₂ₙ₋₂, and determining a point Q on a boundary Eₙ₋₂Dₙ₋₁ such that a right-running characteristic line emanating from the point Q passes through the point E₂ₙ₋₂; determining the flow-field parameters at the point E₂ₙ₋₂ by simultaneously solving the compatibility equations of the streamline and the two characteristic lines passing through the point E₂ₙ₋₂, and repeating this process until a streamline EE₂₁ emanating from point E is determined; and
step 4.3 repeating step 4.1 and step 4.2 to obtain a boundary EE₂₁E₃₁ . . . D that allows one flow-field parameter on the basic flow-field exit boundary (10) to accord with a given distribution rule, wherein the boundary EE₂₁E₃₁ . . . D serves as a lower rectified domain boundary (11).

6. A basic flow-field of double straight conical shock waves with controllable downstream flow-field parameters obtained by the design method according to claim 1.

7. A basic flow-field of double straight conical shock waves with controllable downstream flow-field parameters obtained by the design method according to claim 2.

8. A basic flow-field of double straight conical shock waves with controllable downstream flow-field parameters obtained by the design method according to claim 3.

9. A basic flow-field of double straight conical shock waves with controllable downstream flow-field parameters obtained by the design method according to claim 4.

10. A basic flow-field of double straight conical shock waves with controllable downstream flow-field parameters obtained by the design method according to claim 5.
